(19) United States
(12) Patent Application Publication
(10) Pub. No.: US 2013/0202330 A1
(43) Pub. Date: Aug. 8, 2013

(54) DEVELOPING DEVICE AND IMAGE FORMING APPARATUS

(71) Applicant: FUJI XEROX Co, Ltd., Tokyo (JP)

(72) Inventors: Takashi OCHI, Kanagawa (JP); Yasuaki WATANABE, Kanagawa (JP)

(73) Assignee: FUJI XEROX CO., LTD., Tokyo (JP)

(21) Appl. No.: 13/683,188

(22) Filed: Nov. 21, 2012

(30) Foreign Application Priority Data
Feb. 2, 2012 (JP) 2012-020718

(51) Int. Cl. G03G 15/09

(52) U.S. Cl. CPC G03G 15/0121
USPC 399/269; 399/277

(57) ABSTRACT

A developing device includes first and second developing members facing an image bearing member and respectively having substantially-cylindrical first and second sleeves rotationally driven in a circumferential direction and first and second magnet rollers fixedly supported within the first and second sleeves and provided with magnetic poles in the circumferential direction; a supply member supplying a two-component developer onto the first sleeve; a layer regulating member facing the first sleeve and regulating a layer of the two-component developer thereon; and a magnetic member facing the second sleeve with a certain distance therebetween at a position facing a magnetic pole provided downstream of a development pole and upstream of a removal pole, which are included in the magnetic poles of the second magnet roller, in a rotational direction of the second sleeve. The development pole faces the image bearing member. The removal pole removes the two-component developer from the second sleeve.

### CROSS-REFERENCE TO RELATED APPLICATIONS

This application is based on and claims priority under 35 USC 119 from Japanese Patent Application No. 2012-020718 filed Feb. 2, 2012.

### BACKGROUND

### Technical Field

The present invention relates to developing devices and image forming apparatuses.

### SUMMARY

According to an aspect of the invention, there is provided a developing device including multiple developing members, a supply member, a layer regulating member, and a magnetic member. The multiple developing members are disposed facing an image bearing member having a latent image formed thereon due to a difference in electrostatic potential, and include a first developing member and a second developing member. The first developing member has a substantially-cylindrical first sleeve rotationally driven in a circumferential direction thereof and a first magnet roller fixedly supported within the first sleeve and provided with magnetic poles at multiple positions in the circumferential direction. The second developing member has a substantially-cylindrical second sleeve rotationally driven in a circumferential direction thereof and a second magnet roller fixedly supported within the second sleeve and provided with magnetic poles at multiple positions in the circumferential direction. The supply member supplies a two-component developer containing a toner and a magnetic carrier onto the first sleeve of the first developing member. The layer regulating member faces the first sleeve and regulates a layer of the two-component developer supported on the first sleeve by the first magnet roller provided within the first sleeve. The magnetic member is disposed facing the second sleeve with a certain distance therebetween at a position facing a magnetic pole provided downstream of a development pole and upstream of a removal pole in a rotational direction of the second sleeve included in the second developing member. The magnetic pole, the development pole, and the removal pole are included in the multiple magnetic poles in the second magnet roller of the second developing member having received the two-component developer regulated by the layer regulating member. The development pole is provided at a position that faces the image bearing member. The removal pole removes the two-component developer from a peripheral surface of the second sleeve.

### BRIEF DESCRIPTION OF THE DRAWINGS

Exemplary embodiments of the present invention will be described in detail based on the following figures, wherein:

FIG. 1 schematically illustrates the configuration of an image forming apparatus according to an exemplary embodiment of the present invention;

FIG. 2 is a cross-sectional view schematically illustrating a developing device included in the image forming apparatus shown in FIG. 1, according to an exemplary embodiment of the present invention;

FIG. 3 is a partially-enlarged cross-sectional view of the developing device shown in FIG. 2;

FIGS. 4A and 4B schematically illustrate a position at which a magnetic member is disposed;

FIG. 5 schematically illustrates how toner particles, magnetic carrier particles, and external additive particles behave at a position where a developing roller and a photoconductor drum face each other;

FIGS. 6A and 6B schematically illustrate magnetic lines of force between the magnetic member and the developing roller, and the behavior of a two-component developer;

FIG. 7 schematically illustrates how the two-component developer behaves at a position where the magnetic member and the developing roller face each other in a developing device according to another exemplary embodiment;

FIG. 8 schematically illustrates the arrangement of magnetic poles provided in magnet rollers of a developing device according to another exemplary embodiment; and

FIG. 9 schematically illustrates the arrangement of magnetic poles at a position where a magnetic member and a developing roller face each other, in a developing device according to another exemplary embodiment.

### DETAILED DESCRIPTION

Exemplary embodiments of the present invention will be described below with reference to the drawings.

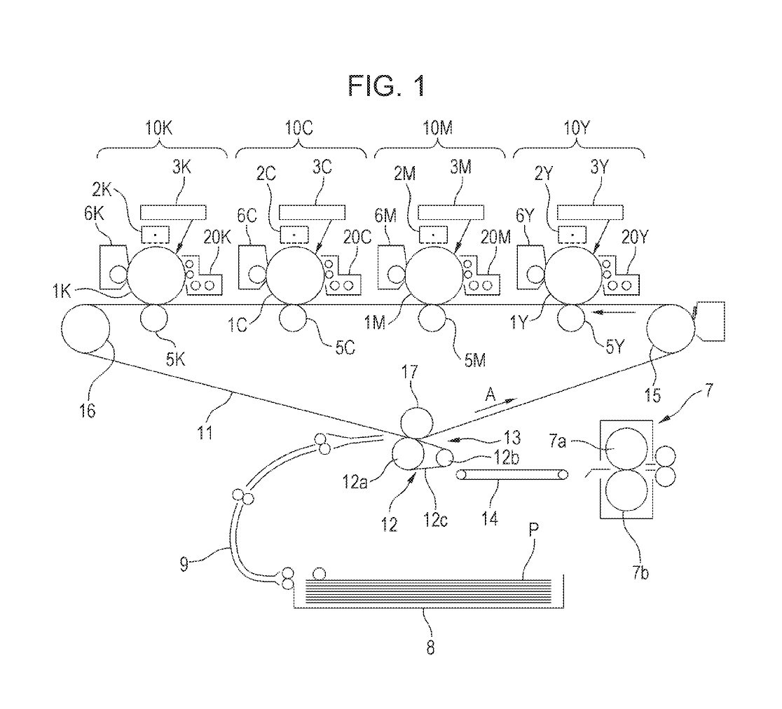

FIG. 1 schematically illustrates the configuration of an image forming apparatus according to an exemplary embodiment of the present invention.

The image forming apparatus forms a color image by using toners of four colors and includes electrophotographic image forming units 10Y, 10M, 10C, and 10K that respectively output yellow (Y), magenta (M), cyan (C), and black (K) images, and an intermediate transfer belt 11 that faces these units.

The intermediate transfer belt 11 is wrapped around a drive roller 15 that is rotationally driven, an adjustment roller 16 that adjusts deviation of the intermediate transfer belt 11 in the width direction thereof, and an opposing roller 17. The intermediate transfer belt 11 is disposed facing the image forming units 10Y, 10M, 10C, and 10K and is rotationally driven in a direction indicated by an arrow A in FIG. 1.

The image forming unit 10Y that forms a yellow toner image, the image forming unit 10M that forms a magenta toner image, the image forming unit 10C that forms a cyan toner image, and the image forming unit 10K that forms a black toner image are arranged in that order from the upstream side in the rotational direction of the intermediate transfer belt 11, and a second-transfer member 12 for performing a second-transfer process is disposed in contact with the intermediate transfer belt 11 at the downstream side of the image forming unit 10K.

A recording medium in the form of a sheet is transported from a recording-medium accommodation section 8 to a second-transfer position 13, at which the second-transfer member 12 faces the intermediate transfer belt 11, via a transport path 9. A transport device 14 that transports the recording medium having toner images transferred thereon and a fixing device 7 that fixes the toner images onto the recording medium by heating and pressing the toner images are provided downstream of the second-transfer position 13 in the transport path 9 for the recording medium.

An output-sheet supporter (not shown) that supports a stack of recording media having toner images fixed thereon is disposed further downstream.

Each of the image forming units 10 has a photoconductor drum 1 that functions as an image bearing member by having an electrostatic latent image formed on a surface thereof. The photoconductor drum 1 is surrounded by a charging device 2 that electrostatically charges the surface of the photoconductor drum 1, a developing device 20 that forms a toner image by selectively transferring toner to the latent image formed on the photoconductor drum 1, a first-transfer roller 5 that first-transfers the toner image on the photoconductor drum 1 onto the intermediate transfer belt 11, and a cleaning device 6 that removes residual toner from the photoconductor drum 1 after the transfer process. Furthermore, for each of the photoconductor drums 1, an exposure device 3 that generates image light based on an image signal is provided. The exposure device 3 radiates the image light onto the electrostatically-charged photoconductor drum 1 at the upstream side of a position where the developing device 20 faces the photoconductor drum 1, thereby writing an electrostatic latent image thereon.

The second-transfer member 12 facing the opposing roller 17 with the intermediate transfer belt 11 interposed therebetween has a second-transfer roller 12a, an auxiliary roller 12b, and a second-transfer belt 12c wrapped around these rollers. The second-transfer belt 12c is nipped between the opposing roller 17 and the second-transfer roller 12a in a state where the second-transfer belt 12c overlaps the intermediate transfer belt 11, and is rotated as the intermediate transfer belt 11 is rotationally driven. When a recording medium is delivered between the intermediate transfer belt 11 and the second-transfer belt 12c, the two belts transport the recording medium by nipping the recording medium therebetween. In order to generate a transfer electric field between the second-transfer roller 12a and the opposing roller 17, a transfer voltage is applied to the opposing roller 17.

The fixing device 7 includes a heating roller 7a having a built-in heating source and a pressure roller 7b that is in pressure contact with the heating roller 7a, and forms a nip at a position where these rollers are in contact with each other. The recording medium having the toner images transferred thereon is delivered to the nip, where the recording medium is heated and pressed between the rotationally-driven heating roller 7a and pressure roller 7b, whereby the toner images are fixed onto the recording medium.

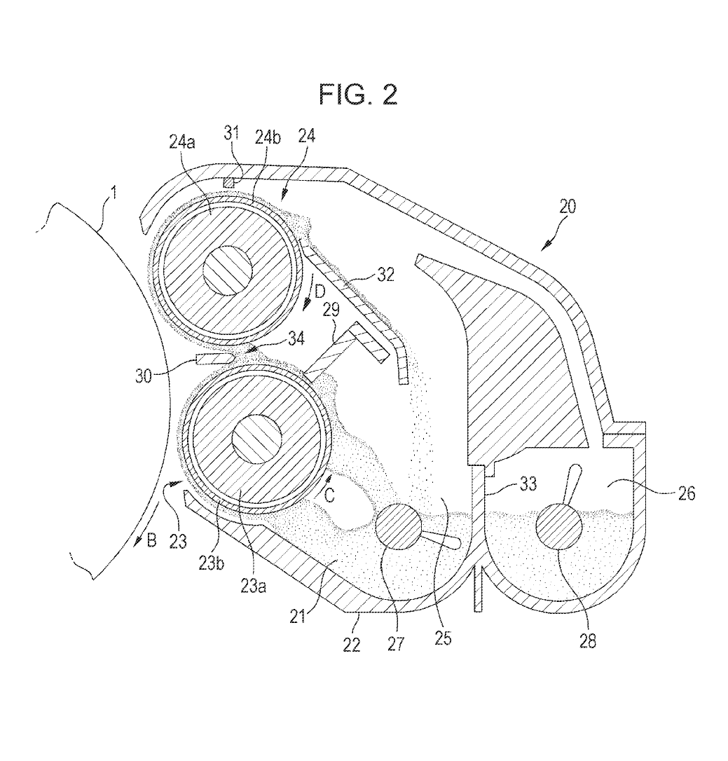

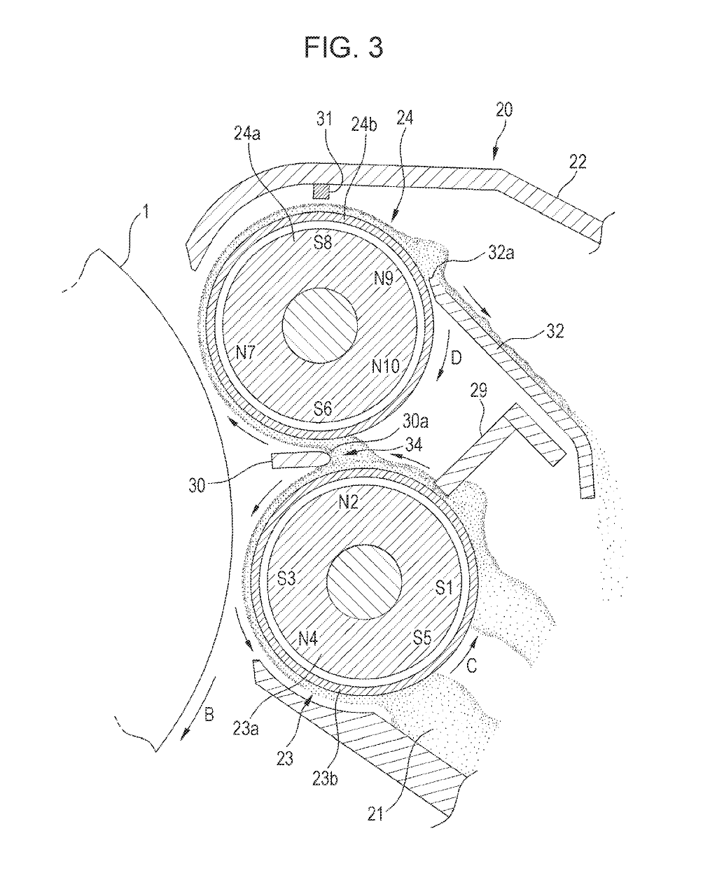

Referring to FIGS. 2 and 3, each developing device 20 includes an accommodation housing 22 that accommodates a two-component developer 21 containing a toner, a magnetic carrier, and an external additive. A first developing roller 23 and a second developing roller 24 functioning as developing members are provided in an area where the accommodation housing 22 opens toward the corresponding photoconductor drum 1. In the accommodation housing 22, a first developer accommodation chamber 25 and a second developer accommodation chamber 26 are provided behind the developing rollers 23 and 24. The developer accommodation chambers 25 and 26 are respectively provided with stirrer transport members 27 and 28 that stir and transport the two-component developer 21 and supply the two-component developer 21 to the first developing roller 23. The first developing roller 23 and the second developing roller 24 are surrounded by a layer regulating member 29 that regulates the layer thickness of the two-component developer 21 magnetically attached to the outer peripheral surface of the first developing roller 23, a distributing member 30 that distributes the two-component developer 21 on the first developing roller 23 to the second developing roller 24, a magnetic member 31 disposed facing the outer peripheral surface of the second developing roller 24, and a guide member 32 that guides the two-component developer 21 removed from the outer peripheral surface of the second developing roller 24 to an operational area of the stirrer transport member 27.

The two-component developer (referred to as “developer” hereinafter) 21 contains a resinous toner, a magnetic carrier, and an external additive. When the developer 21 used in this exemplary embodiment is stirred, the magnetic carrier and the external additive are charged to positive polarity, whereas the toner is charged to negative polarity. By magnetically attaching the positively-charged magnetic carrier to the outer peripheral surfaces of the developing rollers 23 and 24, the negatively-charged toner adhered around the magnetic carrier is transported together with the positively-charged external additive adhered to the toner.

The accommodation housing 22 accommodates the developer 21 and supports the two developing rollers 23 and 24, the stirrer transport members 27 and 28, the layer regulating member 29, the distributing member 30, the magnetic member 31, and the guide member 32. In an opening of the accommodation housing 22 that faces the photoconductor drum 1, the first developing roller 23 and the second developing roller 24 are disposed facing the photoconductor drum 1 with a certain distance therebetween.

The two stirrer transport members 27 and 28 are arranged along the axes of the developing rollers 23 and 24 and are screw-shaped members having helical blades around the central axes thereof. The stirrer transport members 27 and 28 are arranged in parallel to each other with a partition 33 interposed therebetween. The partition 33 has openings (not shown) at opposite ends thereof in the axial direction. The stirrer transport members 27 and 28 transport the developer 21 in the axial direction and are rotationally driven so as to transport the developer 21 in opposite directions from each other. Thus, the developer 21 is delivered between the two stirring areas via the openings provided in the partition 33 so as to circulate between the first developer accommodation chamber 25 and the second developer accommodation chamber 26 partitioned by the partition 33. Then, the developer 21 is supplied to the first developing roller 23 by the stirrer transport member 27, whereby the developer 21 becomes magnetically attached to the outer peripheral surface of the first developing roller 23.

The first developing roller 23 and the second developing roller 24 respectively include magnet rollers 23a and 24a fixedly supported by the accommodation housing 22 and substantially-cylindrical sleeves 23b and 24b supported in a rotatable manner along the outer peripheral surfaces of the magnet rollers 23a and 24a.

The magnet rollers 23a and 24a have multiple magnetic poles in the circumferential direction thereof, and are capable of magnetically attaching or removing the developer 21 to or from the outer peripheral surfaces of the sleeves 23b and 24b by utilizing the effect of a magnetic force. Each of these magnetic poles is provided substantially uniformly in the axial direction of the corresponding magnet roller 23a or 24a, such that substantially the same magnetic field is generated in the surrounding area thereof at any position in the axial direction.

The first sleeve 23b included in the first developing roller 23 is rotationally driven in a direction indicated by an arrow C in FIGS. 2 and 3. Specifically, the first sleeve 23b is rotationally driven such that the peripheral surface thereof moves in the same direction as the photoconductor drum 1 at a position where the peripheral surface faces the photoconductor drum 1 driven in a direction indicated by an arrow B. The second sleeve 24b included in the second developing roller 24 is driven in a direction indicated by an arrow D in FIGS. 2 and 3. Thus, the opposing peripheral surfaces of the first sleeve 23b and the second sleeve 24b move in the same direction at a position where they face each other, that is, the delivery position of the developer 21, whereas the opposing peripheral surfaces of the second sleeve 24b and the photoconductor drum 1 move in opposite directions at a position where they face each other.

As shown in FIG. 3, for example, in the following order in the rotational direction of the first sleeve 23b from a position to which the developer 21 supplied from the stirrer transport member 27 attaches, the magnetic poles provided in the first magnet roller 23a included in the first developing roller 23 include an attachment pole S1 to which the supplied developer 21 attaches, a delivery pole N2 that is magnetized at a position facing the second developing roller 24 and delivers the developer 21 supported by the first sleeve 23b to the second sleeve 24b, a development pole S3 magnetized at a position facing the photoconductor drum 1, a transport pole N4 that transports the developer 21 by attaching it to the outer peripheral surface of the first sleeve 23b, and a removal pole S5 provided adjacent to the attachment pole S1 and having the same polarity as the attachment pole S1.

The second magnet roller 24a included in the second developing roller 24 similarly has five magnetic poles in the circumferential direction thereof. Specifically, in the following order in the rotational direction of the second sleeve 24b from a position facing the first developing roller 23, the five magnetic poles include a reception pole S6 magnetized at a position facing the first developing roller 23 and receiving the developer 21 from the first magnet roller 23a, a development pole N7 that orients the developer 21 toward the photoconductor drum 1 at a position facing the photoconductor drum 1, a transport pole S8 that transports the developer 21 by attaching it to the outer peripheral surface of the second sleeve 24b, and two removal poles N9 and N10 magnetized to the same polarity and spaced apart from each other in the circumferential direction so as to remove the developer 21 therefrom by utilizing repulsive magnetic fields.

The aforementioned magnetic poles S1 to S8 are S-poles, whereas the aforementioned magnetic poles N2 to N10 are N-poles.

The layer regulating member 29 is a tabular member disposed such that an edge thereof faces the outer peripheral surface of the first sleeve 23b, and regulates the amount of developer 21 that is moved while being attached to the first sleeve 23b. The layer regulating member 29 is disposed downstream of a position where the developer 21 is supplied to the first developing roller 23 from the stirrer transport member 27, as viewed in the moving direction of the outer peripheral surface of the first sleeve 23b.

The distributing member 30 protrudes from the downstream side into a gap formed where the first developing roller 23 and the second developing roller 24 face each other, and extends continuously along the axes of the developing rollers 23 and 24. An edge 30a of the distributing member 30 that protrudes into an opposed area 34 between the first developing roller 23 and the second developing roller 24 distributes the developer 21 linked between the first sleeve 23b and the second sleeve 24b toward the first developing roller 23 and the second developing roller 24.

Although the developer 21 transported to the opposed area 34 by the first developing roller 23 is distributed to the first developing roller 23 and the second developing roller 24 in this exemplary embodiment, the distribution ratio may be changed where necessary.

The guide member 32 is a tabular member whose edge 32a is disposed facing the outer peripheral surface of the second sleeve 24b in an area where the repulsive magnetic fields of the two removal poles N9 and N10 provided in the second magnet roller 24a are effective. The guide member 32 guides the developer 21 removed from the second sleeve 24b along the planar surface thereof and introduces the developer 21 to an area within the accommodation housing 22 where the developer 21 is stirred by the stirrer transport member 27.

The magnetic member 31 is disposed facing the transport pole S8 provided in the second magnet roller 24a with a certain distance therebetween. A portion of the magnetic member 31 that faces the transport pole S8 is magnetized to the same polarity as the transport pole S8. Thus, repulsive magnetic fields are generated between the magnetic member 31 and the second magnet roller 24a.

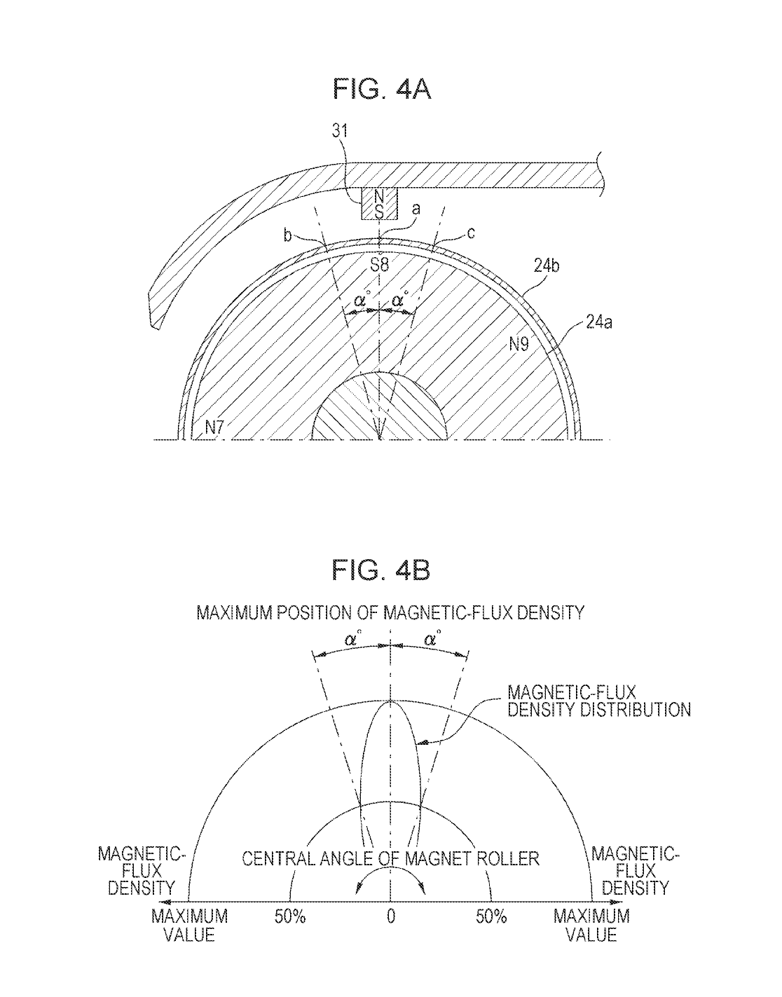

The magnetic member 31 may be disposed facing the second magnet roller 24a within a region in which the magnetic-flux density distribution of the opposing transport pole S8 along the peripheral surface of the second magnet roller 24a is larger than or equal to 50% of the maximum value. For example, as shown in FIGS. 4A and 4B, when the magnetic-flux density distribution of the transport pole S8 along the outer peripheral surface of the second magnet roller 24a (i.e., the magnetic-flux density in a direction extending across the peripheral surface of the second sleeve 24b) is measured, the magnetic-flux density is at a maximum at a central position a of the magnetic pole and gradually decreases toward the opposite sides in the circumferential direction from the central position a until reaching 50% of the maximum value at positions denoted by reference characters b and c. The magnetic member 31 may be disposed facing the second magnet roller 24a within the region between the positions b and c, that is, a region defined by a central angle α° from the central position a of the transport pole S8 toward the opposite sides thereof.

The distance between the magnetic member 31 and the second sleeve 24b may be set on the basis of, for example, the amount of developer 21 supported by the second sleeve 24b or the intensity of the transport pole S8, and may be set between about 200 μm and 2000 μm.

Although the magnetic member 31 is disposed facing the transport pole S8 of the second magnet roller 24a in this exemplary embodiment, if there are multiple magnetic poles disposed downstream of the development pole N7 and upstream of the removal pole N9, the magnetic member 31 may be disposed facing any one of these magnetic poles.

The following description relates to how the toner, the magnetic carrier, and the external additive supplied onto the sleeves 23b and 24b behave in each of the developing devices 20 having the above-described configuration.

The developer 21 stirred by the stirrer transport members 27 and 28 becomes attached onto the first sleeve 23b due to the effect of the attachment pole S1 of the first magnet roller 23a, and is transported as the first sleeve 23b rotates in the direction of the arrow C shown in FIG. 3. The layer regulating member 29 is disposed downstream of the attachment pole S1 and regulates the layer thickness of the developer 21 supported on the first sleeve 23b. Specifically, the amount of developer 21 transported on the first sleeve 23b is adjusted.

The developer 21, whose layer thickness has been regulated, on the first sleeve 23b reaches the opposed area 34 where the first sleeve 23b and the second sleeve 24b face each other as the first sleeve 23b rotates. In the opposed area 34, the delivery pole N2 of the first magnet roller 23a and the reception pole S6 of the second magnet roller 24a face each other, such that the magnetic carrier is linked between these magnetic poles having different polarities, whereby the developer 21 is supported and bridged between the two poles.

The distributing member 30 is disposed in the opposed area 34. The edge 30a of the distributing member 30 abuts on the developer 21 with the magnetic carrier linked between the first sleeve 23b and the second sleeve 24b so as to distribute the developer 21 toward the first sleeve 23b and the second sleeve 24b.

The developer 21 received by the second sleeve 24b from the first sleeve 23b in this manner is transported as the second sleeve 24b rotates, thereby reaching a position facing the photoconductor drum 1.

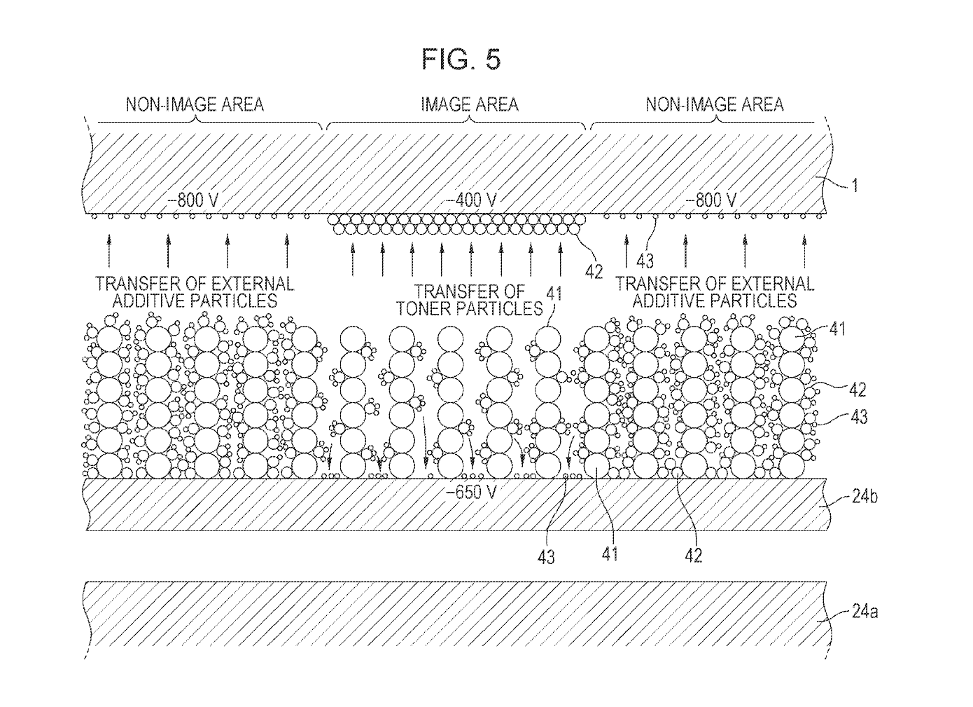

In a development region facing the photoconductor drum 1, the magnetic field of the development pole N7 magnetized by the second magnet roller 24a causes magnetic carrier particles 41 to form chains, as shown in FIG. 5, and a development bias voltage applied between the photoconductor drum 1 and the second sleeve 24b or the second magnet roller 24a causes toner particles 42 adhered to the chained magnetic carrier particles 41 on the second sleeve 24b to transfer to an image area, that is, a latent image, on the photoconductor drum 1. In this exemplary embodiment, the photoconductor drum 1 is electrostatically charged to, for example, −800 V, and the image area (i.e., an area to which the toner particles 42 are to be adhered) is subsequently exposed to light so that the electric potential decreases to −400 V. Then, due to the development bias voltage, in which direct current and alternating current are superimposed, applied to the second sleeve 24b, the electric potential of the direct-current component becomes −650 V. Accordingly, the negatively-charged toner particles 42 transfer to the surface of the photoconductor drum 1 due to an electric field generated between the outer peripheral surface of the second sleeve 24b and the image area of the photoconductor drum 1. Therefore, the toner concentration in the developer 21 on the second sleeve 24b decreases. In this case, the magnetic carrier particles 41 are constrained by the magnetic field of the second magnet roller 24a so as to be retained on the second sleeve 24b. Furthermore, external additive particles 43 are positively charged, and some of them are pulled toward the second sleeve 24b between the chained magnetic carrier particles 41 so as to adhere to the surface of the second sleeve 24b.

On the other hand, a non-image area on the photoconductor drum 1 is not exposed to the light so that the electric potential thereof is maintained at −800 V, whereby an electric field in the opposite direction from that in the image area is generated between the non-image area and the second sleeve 24b. Therefore, the positively-charged toner particles 42 are retained on the second sleeve 24b, and a pulling force acting from the chained magnetic carrier particles 41 toward the surface of the second sleeve 24b causes some of the toner particles 42 to adhere to the surface of the second sleeve 24b. Furthermore, the positively-charged external additive particles 43 and magnetic carrier particles 41 receive a pulling force toward the photoconductor drum 1, so that some of the external additive particles 43 transfer to the photoconductor drum 1. The magnetic carrier particles 41 are constrained by the magnetic field of the second magnet roller 24a so as to be retained on the second sleeve 24b.

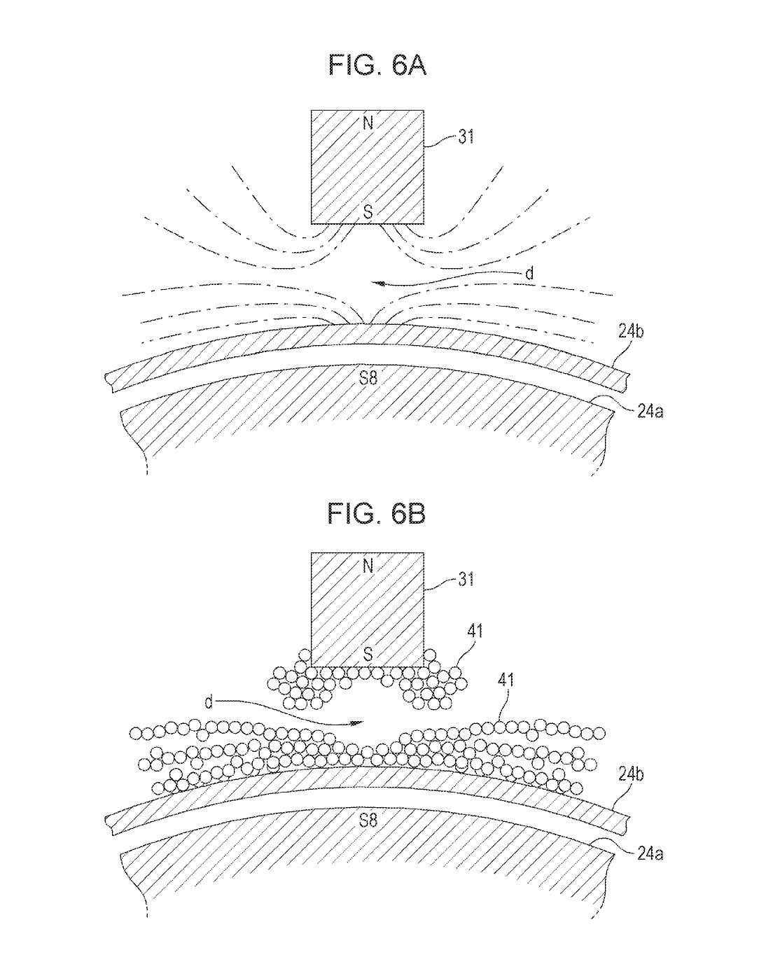

After some of the external additive particles 43 and the toner particles 42 have transferred from the developer 21 on the second sleeve 24b, the developer 21 on the second sleeve 24b moves to the position facing the magnetic member 31. At this position, the transport pole S8 is magnetized by the second magnet roller 24a, and an S-pole having the same polarity as the transport pole S8 is magnetized in the magnetic member 31, whereby repulsive magnetic fields are generated. Therefore, magnetic lines of force as shown in FIG. 6A are generated between the magnetic member 31 and the second sleeve 24b, thereby forming a region d where the retainability of the magnetic carrier particles 41 is low. Consequently, as shown in FIG. 6B, the magnetic carrier particles 41 on the second sleeve 24b are pressed onto the surface of the second sleeve 24b. When the second sleeve 24b continues to rotate in this state, the pressed magnetic carrier particles 41 are rubbed against the surface of the second sleeve 24b, whereby the toner particles 42 and the external additive particles 43 adhered to the outer peripheral surface of the second sleeve 24b become adhered to the magnetic carrier particles 41 so as to be scraped off.

The surface of the second sleeve 24b is roughened to maintain the transport efficiency of the magnetic carrier particles 41 attached thereto by the magnetic force of the second magnet roller 24a, and is thus provided with multiple recesses.

After passing through the opposed area between the second developing roller 24 and the magnetic member 31, the developer 21 on the second sleeve 24b moves to the position where the removal pole N9 is provided. The removal pole N10 having the same polarity as the removal pole N9 is provided downstream thereof such that repulsive magnetic fields are generated therebetween. Thus, the magnetic carrier particles 41 are released and removed from the second sleeve 24b together with the toner particles 42 and the external additive particles 43. The guide member 32 is disposed such that the edge 32a thereof protrudes to this position. Thus, the removed developer 21, that is, the magnetic carrier particles 41 having the toner particles 42 and the external additive particles 43 adhered thereto, moves along the guide member 32 so as to be returned to the area where the stirrer transport member 27 is driven. After the developer 21 is stirred, the developer 21 is supplied onto the first sleeve 23b again.

If the magnetic member 31 is not provided at the position facing the transport pole S8, the outer peripheral surface of the second sleeve 24b would be transported to the position provided with the removal pole N9 in a state where a large number of toner particles 42 are adhered to the area that faces the non-image area at the development region and a large number of external additive particles 43 are adhered to the area that faces the image area. When the magnetic carrier particles 41 are subsequently removed due to the repulsive magnetic fields, the toner particles 42 and the external additive particles 43 adhered to the second sleeve 24b would remain thereon without being removed therefrom. With regard to the distribution of residual toner particles 42 and external additive particles 43, unevenness may occur therein based on the image on the photoconductor drum 1 facing the second sleeve 24b at the development region. If the developer 21 is supplied again to the opposed position between the first sleeve 23b and the second sleeve 24b and is transported to the development region while such unevenness remains, the history of the opposing image in the previous rotation may appear in a subsequent image to be developed. In contrast, in the developing device 20 according to this exemplary embodiment, the magnetic carrier particles 41 rub against the second sleeve 24b so as to make the toner particles 42 and the external additive particles 43 adhere to the magnetic carrier particles 41 at the position facing the magnetic member 31, and the magnetic carrier particles 41 are removed at the position facing the removal pole N9 together with a large number of toner particles 42 and external additive particles 43. Therefore, unevenness in density based on the previously-developed image, that is, the image history, may less likely to appear in the subsequent image to be developed.

With regard to the first sleeve 23b after delivering a portion of the developer 21 to the second sleeve 24b at the opposed area 34 between the first sleeve 23b and the second sleeve 24b, the outer peripheral surface thereof rotates so as to transport the developer 21 to the position facing the photoconductor drum 1. Then, the first sleeve 23b transfers the toner to the latent image on the photoconductor drum 1, so that the latent image is developed. The first sleeve 23b supporting the developer 21 containing the residual toner and external additive after the developing process continues to rotate so that the developer 21 remaining on the first sleeve 23b is removed therefrom at the removal pole S5. The removed developer 21 is returned to the operational area of the stirrer transport member 27 where the developer 21 and the other developer therein are stirred together. Subsequently, the developer 21 is supplied again onto the first sleeve 23b at the position where the attachment pole S1 is provided.

When the developer 21 supported by the first sleeve 23b passes through the development region where the photoconductor drum 1 and the first sleeve 23b face each other, the toner particles transfer to the image area, and the toner particles and the external additive particles adhere to the first sleeve 23b, similarly to when the developer 21 passes through the region where the photoconductor drum 1 and the second sleeve 24b face each other. However, a portion of the developer 21 attached to the first sleeve 23b is retained at the upstream side of the position facing the layer regulating member 29 and is rubbed against the outer peripheral surface of the first sleeve 23b, as well as being stirred. Therefore, unevenness in toner particles and external additive particles occurring when passing through the development region may be eliminated, thereby reducing the occurrence of the image history appearing in the subsequent image.

At the position where the second sleeve 24b and the magnetic member 31 face each other in the exemplary embodiment described above, the transport pole S8 of the second magnet roller 24a and the opposing magnetic pole provided in the magnetic member 31 have the same polarity so that repulsive magnetic fields are generated in the opposed area. Alternatively, the transport pole S8 and the magnetic pole of the magnetic member 31 may have opposite polarities.

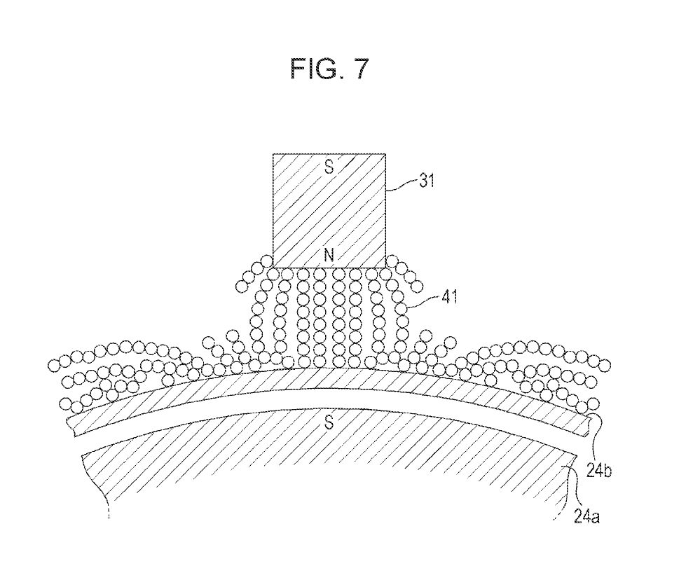

If the transport pole S8 of the second sleeve 24b and the magnetic pole of the magnetic member 31 have opposite polarities, the magnetic field between the N-pole and the S-pole causes the magnetic carrier particles 41 to be linked to each other so as to form chains in a state where the toner particles 42 are adhered thereto, as shown in FIG. 7, thereby bridging the linked magnetic carrier particles 41 between the second sleeve 24b and the magnetic member 31. When the outer peripheral surface of the second sleeve 24b rotates, a force that causes the linked magnetic carrier particles 41 to be retained within the magnetic field acts thereon, causing the magnetic carrier particles 41 to rub against the outer peripheral surface of the second sleeve 24b. Thus, the toner particles 42 and the external additive particles 43 adhered to the outer peripheral surface of the second sleeve 24b are scraped off by the magnetic carrier particles 41, whereby the image history may be eliminated.

Furthermore, although the magnetic member 31 is magnetized in the above exemplary embodiment, a non-magnetized magnetic member may be disposed as an alternative. In such a device, the transport pole S8 magnetizes the opposing magnetic member so that a magnetic field similar to the device shown in FIG. 7 is generated. Therefore, the image history may be eliminated by retaining the magnetic carrier particles 41 between the magnetic member and the second sleeve 24b.

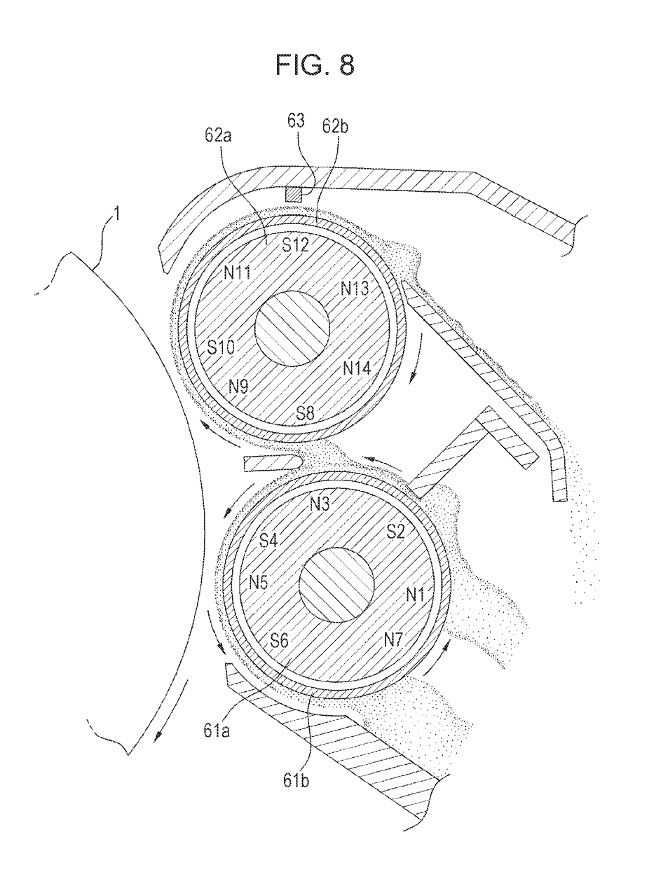

Although each of the first magnet roller 23a and the second magnet roller 24a is provided with five magnetic poles in the above exemplary embodiment, the number of magnetic poles is not limited to five, and may alternatively be, for example, seven, as shown in FIG. 8.

In such a developing device, in the following order in the rotational direction of a first sleeve 61b from a position to which the developer is supplied onto the first sleeve 61b, a first magnet roller 61a is provided with an attachment pole N1 to which the developer supplied by the stirrer transport member attaches, a first transport pole S2 that supports the developer on the first sleeve 61b, a delivery pole N3 that delivers the developer to a second sleeve 62b, a second transport pole S4, a development pole N5 that faces the photoconductor drum 1, a third transport pole S6, and a removal pole N7 that removes the developer from the first sleeve 61b.

Furthermore, in the following order in the rotational direction of the second sleeve 62b from a position to which the developer is transferred from the first sleeve 61b, a second magnet roller 62a is provided with a reception pole S8 that receives the developer from the first sleeve 61b, a first transport pole N9, a development pole S10, a second transport pole N11, a third transport pole S12 facing a magnetic member 63, and two removal poles N13 and N14.

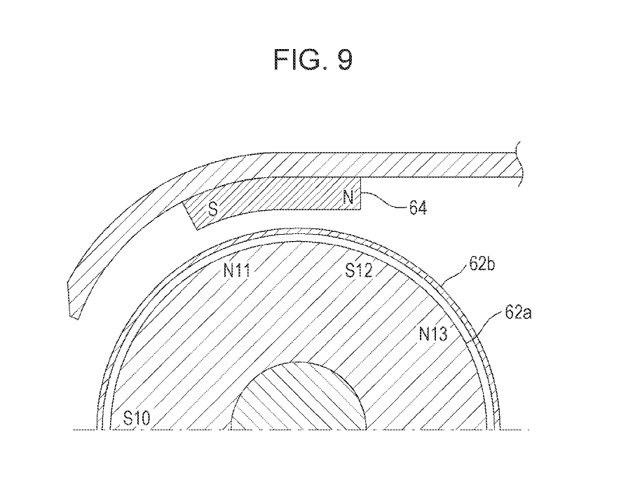

Referring to FIG. 8, when two transport poles are provided downstream of the development pole S10 and upstream of the removal pole N13, respectively, in the rotational direction of the second sleeve 62b, the magnetic member 63 may be disposed so as to face one of the transport poles. Furthermore, referring to FIG. 9, a magnetic member 64 may be provided so as to face both of the two transport poles N11 and S12. In this case, in the area where the magnetic member 64 faces the two transport poles N11 and S12, repulsive magnetic fields may be generated, or attractive magnetic fields may be generated. Alternatively, repulsive magnetic fields may be generated in the area where one of the transport poles and the magnetic member 64 face each other, and attractive magnetic fields may be generated in the area where the other transport pole and the magnetic member 64 face each other.

With the magnetic member 64 disposed facing the two transport poles N11 and S12 provided in the second magnet roller 62a, the range in which the magnetic carrier scrapes off the surface of the second sleeve 62b is increased, as shown in FIG. 9, whereby the amount of toner or external additive remaining on the second sleeve 62b may be reduced, as compared with a case where the magnetic member 64 is disposed facing one transport pole.

The number and the arrangement pattern of magnetic poles provided in the first magnet roller and the second magnet roller are not limited to those shown in FIG. 2 or 8 and may be changed so long as transport poles are provided downstream of a development pole and upstream of a removal pole in the rotational direction of the second sleeve.

Furthermore, other features of the above exemplary embodiments are not limited thereto, and may be implemented as other exemplary embodiments of the present invention so long as they are within the scope thereof. For example, the number of developing rollers is not limited to two, and may be three or more. Moreover, the rotational direction of the developing rollers may be changed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A developing device comprising:
a plurality of developing members disposed facing an image bearing member having a latent image formed thereon due to a difference in electrostatic potential, the plurality of developing members including a first developing member and a second developing member, the first developing member having a substantially-cylindrical first sleeve rotationally driven in a circumferential direction thereof and a first magnet roller fixedly supported within the first sleeve and provided with magnetic poles at a plurality of positions in the circumferential direction, the second developing member having a substantially-cylindrical second sleeve rotationally driven in a circumferential direction thereof and a second magnet roller fixedly supported within the second sleeve and provided with magnetic poles at a plurality of positions in the circumferential direction;
a supply member that supplies a two-component developer containing a toner and a magnetic carrier onto the first sleeve of the first developing member;
a layer regulating member that faces the first sleeve and regulates a layer of the two-component developer supported on the first sleeve by the first magnet roller provided within the first sleeve; and
a magnetic member disposed facing the second sleeve with a certain distance therebetween at a position facing a magnetic pole provided downstream of a development pole and upstream of a removal pole in a rotational direction of the second sleeve included in the second developing member, the magnetic pole, the development pole, and the removal pole being included in the plurality of magnetic poles in the second magnet roller of the second developing member having received the two-component developer regulated by the layer regulating member, the development pole being provided at a position that faces the image bearing member, the removal pole removing the two-component developer from a peripheral surface of the second sleeve.

2. The developing device according to claim 1, wherein a portion of the magnetic member that faces the second sleeve is magnetized to the same polarity as the magnetic pole of the second magnet roller that faces the magnetic member.

3. The developing device according to claim 1, wherein the second magnet roller has a plurality of magnetic poles located downstream of the development pole and upstream of the removal pole, and
wherein the magnetic member is disposed facing the plurality of magnetic poles.

4. An image forming apparatus comprising:
an image bearing member having an endless peripheral surface on which a latent image is formed due to a difference in electrostatic potential;
the developing device according to claim 1 that forms a toner image by adhering toner to the latent image on the image bearing member;
a transfer device that transfers the formed toner image onto a transfer medium; and
a fixing device that fixes the toner image onto the transfer medium.
